(19) United States
(12) Patent Application Publication
(10) Pub. No.: US 2013/0187559 A1
(43) Pub. Date: Jul. 25, 2013

(54) POWER SWITCH STRUCTURE WITH BOTH LIGHT EMISSION AND DC POWER CONVERSION FUNCTIONS

(71) Applicant: LAI-FU WU, New Taipei City (TW)

(72) Inventor: LAI-FU WU, New Taipei City (TW)

(21) Appl. No.: 13/354,310

(22) Filed: Jan. 19, 2012

(51) Int. Cl. H05B 37/00

(52) U.S. Cl. 315/201; 315/200 R

(57) ABSTRACT

A power switch structure with both light emission and DC power conversion functions is electrically connected to an electric appliance and an AC power supply, and the power switch structure includes a casing, a converting module installed in the casing and electrically connected to the AC power supply for converting AC power into DC power, a control switch electrically connected to the electric appliance, the AC power supply and the converting module for switching a using status of the electric appliance, and switching to an output of the DC power according to the using status of the electric appliance, and a first light source module electrically connected to the control switch and driven by the DC power to emit light.

### BACKGROUND OF THE INVENTION

1. Field of the Invention

The present invention relates to power switches, in particular to a power switch structure with both light emission and DC power conversion functions, and the power switch structure is capable of converting AC power into DC power and driving a light source module and/or a DC power appliance for its use.

2. Description of the Related Art

To facilitate users to find a power switch in a dark place or at night, a conventional power switch generally includes a device with a light emitting source installed inside the power switch and having a small window formed on a surface of the device for passing a weak indicating light. When the space is too large or the distance is too far, the weak brightness and insufficient illumination fail to serve as an indicating light source or fail to provide sufficient indicating effect to users. Therefore, users have to purchase additional light indicating lamps and waste unnecessary material costs. In recent years, DC power appliances are used extensively, and most of the DC power appliances come with an AC/DC adaptor for converting AC power coming from utility power into DC power for operating the electric appliances. However, the additional adapter also causes an unnecessary waste.

In view of the shortcoming of the prior art, the inventor of the present invention based on years of experience in the related industry to conductive extensive researches and experiments, and finally developed a power switch structure with both light emission and DC power conversion functions, not only capable of converting the AC power coming from the utility power into DC power for the operation of the electric appliances, but also capable of transmitting light emitted from an LED light source using DC power and installed on an inner side of a casing and through a light guide plate installed on an outer side of the casing, so as to emit light from a part or the whole of a surface of the light guide plate and produce a light indicating effect. Therefore, the invention can overcome the shortcoming of the conventional power switch having a too-weak light emitting source. In addition, the DC power can be supplied to the DC power appliance for the operation of electric appliance without requiring the installation of an additional AC/DC adaptor, so as to waive the unnecessary installation of the AC/DC adaptor, and enhance the quality and environment of using electric power.

### SUMMARY OF THE INVENTION

Therefore, it is a primary objective of the present invention to provide a power switch structure with both light emission and DC power conversion functions, wherein a converting module is installed inside a casing of the power switch structure and provided for converting AC power coming from the utility power into DC power, and supplying the DC power to an AC power appliance and/or a DC power appliance without requiring the installation of an additional current converting module in the DC power appliance.

A secondary objective of the present invention is to provide a power switch structure with both light emission and DC power conversion functions, wherein a first light source module is installed on the casing and electrically coupled to the converting module, and the first light source module can be driven by the DC power to emit light. In addition, the first light source module includes a first LED light source and a second LED light source, and the two LED light sources can emit lights of different colors which serve as the indicating lights for the using status of the electric appliance.

A further objective of the present invention is to provide a power switch structure with both light emission and DC power conversion functions, wherein a second light emitting module is installed to enhance the light indicating effect.

To achieve the aforementioned objective, the present invention provides a power switch structure with both light emission and DC power conversion functions, and the power switch structure is electrically coupled to an electric appliance and an AC power supply, and comprises: a casing, having a frame and an installing portion, and the installing portion being disposed at the center of the frame; a converting module, installed in the casing and electrically coupled to the AC power supply, for converting AC power into DC power; a control switch, installed at the installing portion, and electrically coupled to the electric appliance, the AC power supply and the converting module, for switching a using status of the electric appliance, and the control switch having a first DC power contact and a second DC power contact provided for switching the DC power to be outputted to the first DC power contact or the second DC power contact according to the using status of the electric appliance; and a first light source module, having a first LED light source and being electrically coupled to the first DC power contact and driven by the DC power to emit light. Wherein, the first light emitting module includes a first LED light source and is electrically coupled to the first DC power contact, and a first light guide plate is installed on a side of the first LED light source, and the first LED light source is driven by the DC power to light up the first light guide plate. Wherein, the first light source module is installed in the casing, and the frame further includes a hollow portion provided for installing the first light guide plate.

When the electric appliance is situated at an OFF state, the first LED light source is electrically conducted, and at least one first pattern layer is formed on the first light guide plate and provided for the first LED light source to show bright and dark lights through the pattern layer.

To enhance the convenience of operating the interface, the control switch is either a capacitive touch panel unit or a mechanical press key unit.

To distinguish the using status of the electric appliance, a second LED light source is installed on a side of the first light guide plate and the second DC power contact is electrically coupled, such that the second LED light source and the first LED light source can emit lights of different colors.

To enhance the display of the electric appliance, a second light source module is provided, and the second light source module has a third LED light source and is electrically coupled to the second DC power contact, and a second light guide plate is installed on a side of the third LED light source. When the DC power drives the light source to emit light, the light is provided through the second light guide plate. In addition, the second light guide plate has at least one second pattern layer formed thereon and provided for the third LED light source to show bright and dark lights through the second pattern layer.

The effect of the present invention is to provide a power switch structure with both light emission and DC power conversion functions, wherein the first LED light source, the second LED light source, and the first light guide plate of the electric appliance are switched alternately to provide an indicating function. In addition, when the electric appliance is turned off, the first LED light source will be turned on automatically to provide the illuminating effect for a dark environment and enhance the convenience of the application. To enhance the display of the electric appliance, a third LED light source and a second light guide plate are further provided, so that their light emitting effect can indicate the using status of the electric appliance. In addition, the scope of the application can be extended further to improve users' visual sensation for the indicating function, such that users with listening disorder or in a noisy environment can know about the using status of the electric appliance quickly.

### BRIEF DESCRIPTION OF THE DRAWINGS

FIG. 1 is an exploded view of a power switch structure of the present invention;

FIG. 2 is a block diagram of hardware of the present invention;

FIG. 3A is a first schematic view of a preferred embodiment of the present invention;

FIG. 3B is a second schematic view of the preferred embodiment of the present invention;

FIG. 4A is a first schematic view of another preferred embodiment of the present invention; and

FIG. 4B is a second schematic view of the preferred embodiment of the present invention.

### DETAILED DESCRIPTION OF THE PREFERRED EMBODIMENTS

The technical content of the present invention will become apparent by the detailed description of the following embodiments and the illustration of related drawings as follows.

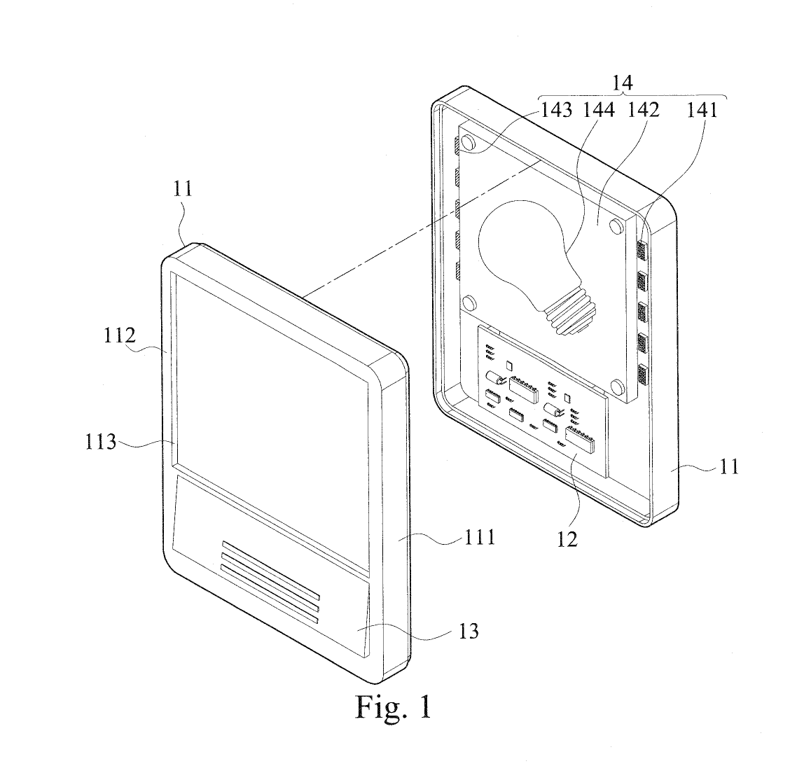

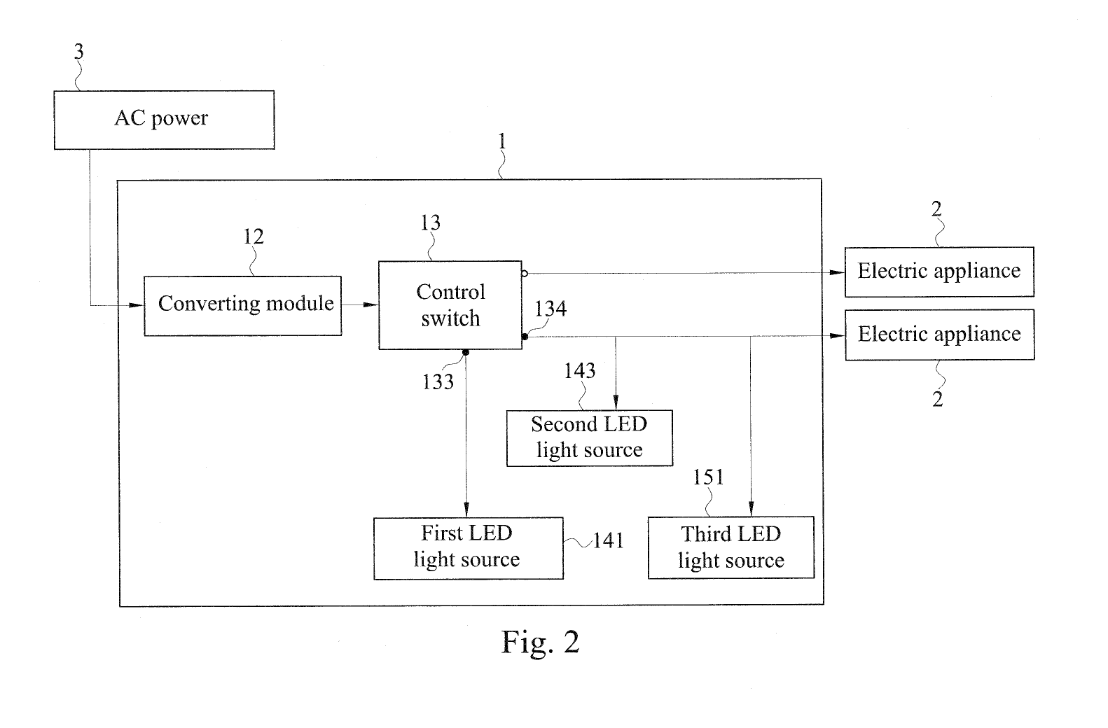

With reference to FIGS. 1, 2, 3A and 3B for an exploded view, a block diagram, and schematic views of a preferred embodiment of the present invention respectively, a power switch structure with both light emission and DC power conversion functions 1 of the present invention is electrically coupled to an electric appliance 2 and an AC power supply 3, and the power switch structure comprises a casing 11, a converting module 12, a control switch 13 and a first light source module 14.

Wherein, the casing 11 has a frame 111 and an installing portion 112, and the installing portion 112 is disposed at the center of the frame 111.

The converting module 12 is installed in the casing 11 and electrically coupled to the AC power supply for converting AC power into DC power. It is noteworthy to point out that the electric appliance 2 is driven by an input of the DC power or operated by using the AC power.

The control switch 13 is installed at the installing portion 112 and electrically coupled to the electric appliance 2, the AC power supply 3 and the converting module 12 for switching the using status of the electric appliance 2, and the control switch 13 has a first DC power contact 133 and a second DC power contact 134 provided for selectively switching the output of the DC power to the first DC power contact 133 or the second DC power contact 134 according to the using status of the electric appliance 2. It is noteworthy to point out that the control switch 13 is a mechanical press key unit 131 provided to improve the flexibility and convenience of the application.

The first light source module 14 has a first LED light source 141 and is electrically coupled to the first DC power contact 133 and a first light guide plate 142 installed on a side of the first LED light source 141. When the DC power drives the light source to emit light, the light will be emitted through the first light guide plate 142. It is noteworthy to point out that the first light source module 14 is installed the casing 11, and the frame 111 further has a hollow portion 113 for installing the first light guide plate 142 inside the hollow portion 113, and the first light guide plate 142 has at least one first pattern layer 144 provided for the first LED light source 141 to show bright and dark lights through the first pattern layer 144.

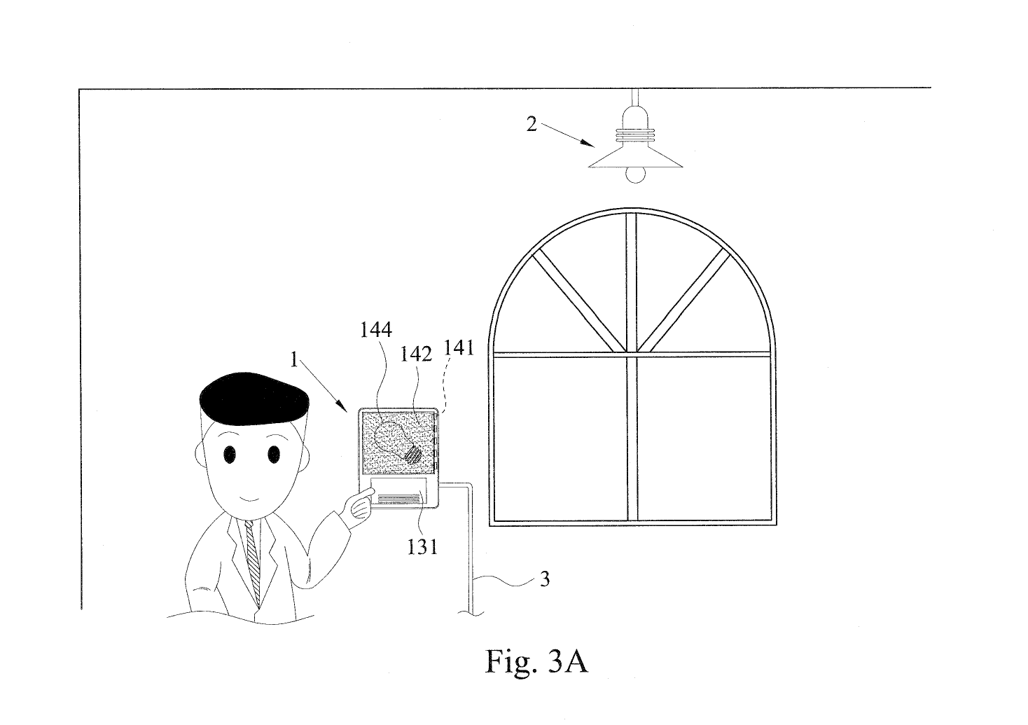

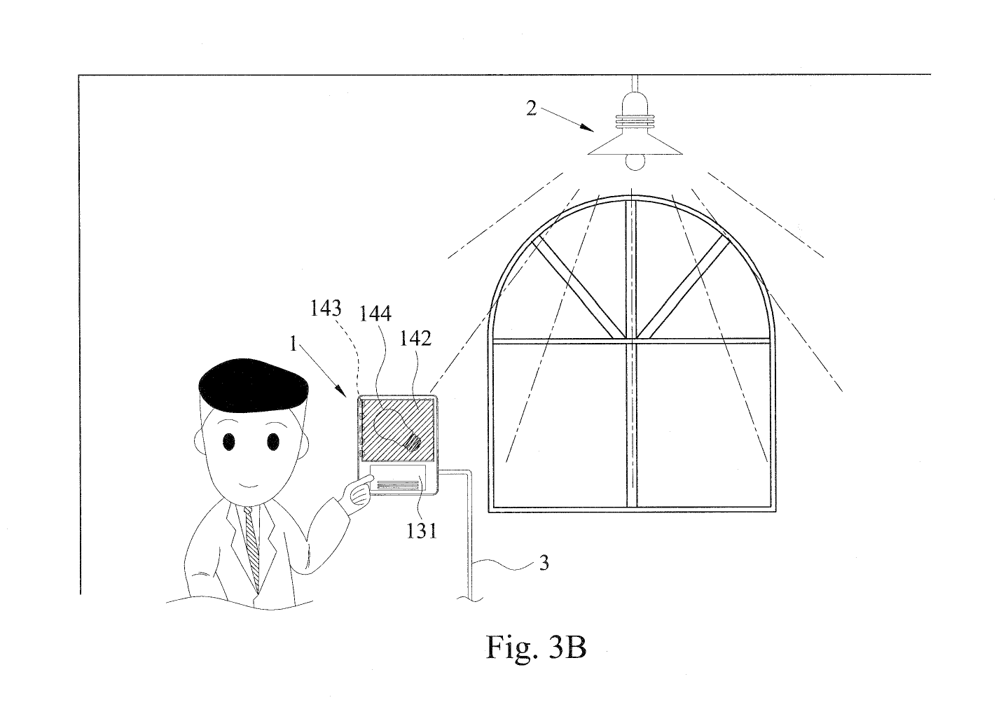

With reference to FIGS. 3A and 3B, the power switch further comprises a second LED light source 143 installed on a side of the first light guide plate 142, and is electrically coupled to the second DC power contact 134, such that the second LED light source 143 and the first LED light source 141 emit lights of different colors to enhance the display of the electric appliance 2. When the electric appliance 2 is at an ON state, the second LED light source 143 is also turned on to emit green light, and the first LED light source 141 is at an OFF state. On the other side, when the electric appliance 2 is at an OFF state, the second LED light source 143 is also as the OFF state, and the first LED light source 141 is at an ON state to emit red light.

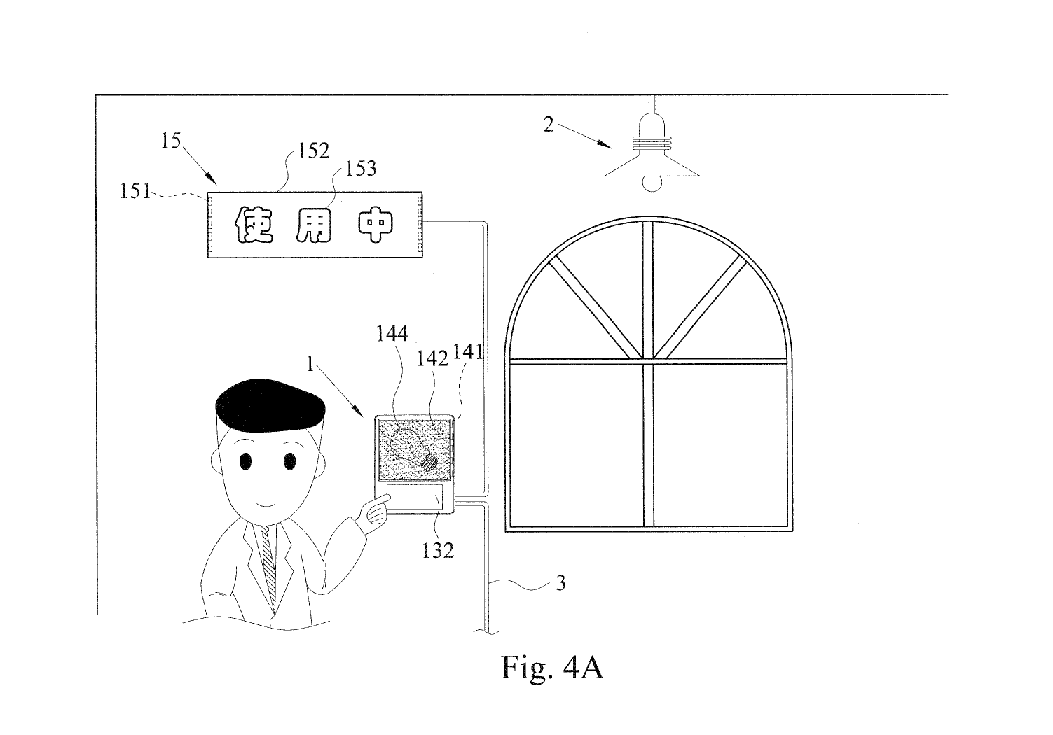

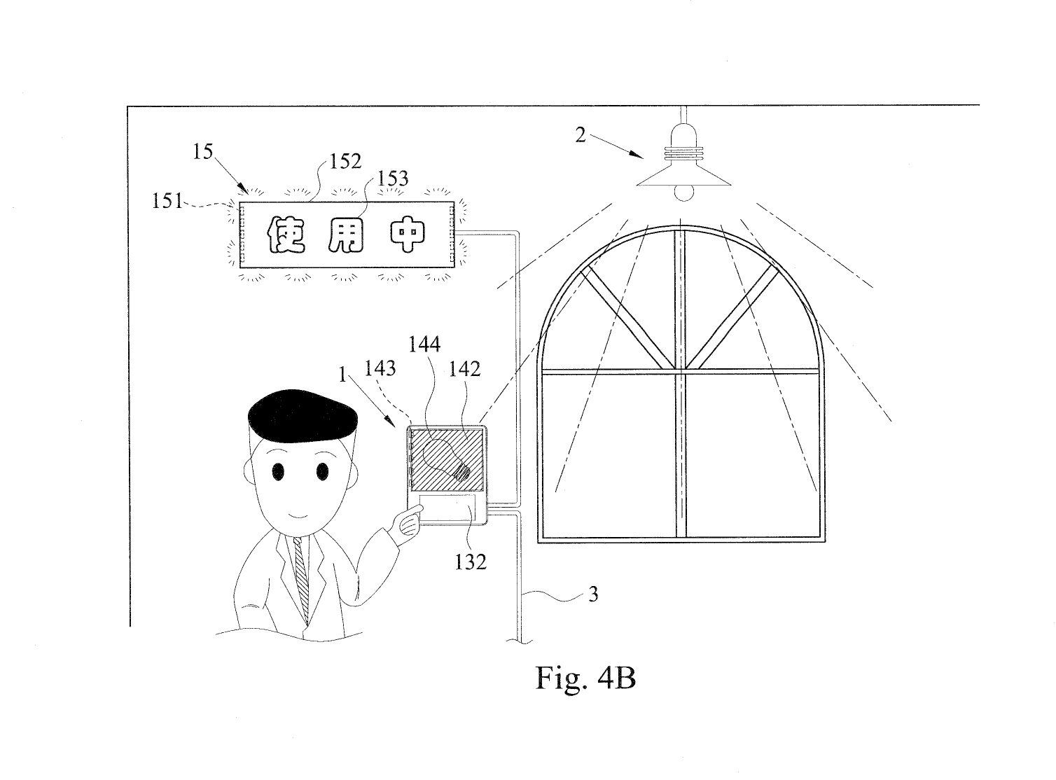

In another preferred embodiment, the application of the power switch structure with both light emission and DC power conversion functions 1 of the present invention can be extended to emphasize on the indicating function of the using status of the electric appliance 2. With reference to FIGS. 4A and 4B for the first and second schematic views of another preferred embodiment of the present invention respectively, the power switch structure further comprises a second light source module 15, and the second light source module 15 has a third LED light source 151 and is electrically coupled to the second DC power contact 134, and a second light guide plate 152 installed on a side of the third LED light source 151. When the DC power drives the light source to emit light, the light is emitted through the second light guide plate 152, wherein the second light guide plate 152 includes at least one second pattern layer 153 formed thereon and provided for the third LED light source 151 to show bright and dark lights through the second pattern layer 153, and the capacitive touch panel unit 132 is provided for controlling the ON state of the electric appliance 2. If the electric appliance 2 is situated at the ON state, the first light guide plate 142 emits green light through the second LED light source 143, and the second light guide plate 152 shows a bright light through the third LED light source 151, and the second pattern layer 153 formed on the second light guide plate 152 will provide an indicating function. On the other hand, when the electric appliance 2 is at the OFF state, only the first LED light source 141 emits red light which serves as an indicating light.

In summation, the effect of the present invention is to provide a power switch structure with both light emission and DC power conversion functions, wherein the first LED light source, the second LED light source, and the first light guide plate of the electric appliance are switched alternately, such that the first LED light source can emit light through the first light guide plate to provide the illuminating effect for a dark environment to facilitate users to find the power switch and provide the indicating effect for users to switch the power switch. To enhance the overall convenience, the power switch structure further comprises a capacitive touch panel unit or a mechanical press key unit. To enhance the display of the electric appliance, a third LED light source and a second light guide plate are further provided, so that their light emitting effect can indicate the using status of the electric appliance. The scope of the application can be extended further to improve the visual sensation for the indicating function, such that users with listening disorder or in a noisy environment can know about the using status of the electric appliance quickly.

What is claimed is:

1. A power switch structure with both light emission and DC power conversion functions, electrically coupled to an electric appliance and an AC power supply, and comprising:
a casing, having a frame and an installing portion, and the installing portion being disposed at the center of the frame;
a converting module, installed in the casing and electrically coupled to the AC power supply, for converting AC power into DC power;
a control switch, installed at the installing portion, and electrically coupled to the electric appliance, the AC power supply and the converting module, for switching a using status of the electric appliance, and the control switch having a first DC power contact and a second DC power contact provided for switching the DC power to be outputted to the first DC power contact or the second DC power contact according to the using status of the electric appliance; and
a first light source module, having a first LED light source, and being electrically coupled to the first DC power contact and driven by the DC power to emit light.

2. The power switch structure with both light emission and DC power conversion functions as recited in claim 1, further comprising a first light guide plate installed on a side of the first LED light source, and the first LED light source is driven by the DC power to light up the first light guide plate.

3. The power switch structure with both light emission and DC power conversion functions as recited in claim 2, wherein the first light source module is installed in the casing, and the frame further includes a hollow portion provided for installing the first light guide plate.

4. The power switch structure with both light emission and DC power conversion functions as recited in claim 2, wherein the first light guide plate includes at least one first pattern layer formed thereon and provided for the first LED light source to show bright and dark lights through the first pattern layer.

5. The power switch structure with both light emission and DC power conversion functions as recited in claim 2, further comprising a second LED light source installed on a side of the first light guide plate, and electrically coupled to the second DC power contact, for driving the second LED light source and the first LED light source to emit lights of different colors.

6. The power switch structure with both light emission and DC power conversion functions as recited in claim 1, wherein the control switch is one selected from the collection of a capacitive touch panel unit and a mechanical press key unit.

7. The power switch structure with both light emission and DC power conversion functions as recited in claim 1, further comprising a second light source module, and the second light source module having a third LED light source, and being electrically coupled to the second DC power contact, and a second light guide plate installed on a side of the third LED light source, such that the third LED light source can be driven by the DC power to light up the second light guide plate.

8. The power switch structure with both light emission and DC power conversion functions as recited in claim 7, wherein the second light guide plate includes at least one second pattern layer formed thereon, and provided for the third LED light source to show bright and dark lights through the second pattern layer.
